(19) United States
(12) Patent Application Publication
(10) Pub. No.: US 2009/0271835 A1
(43) Pub. Date: Oct. 29, 2009

(54) Set top box system parameter retrieval

(76) Inventors: Tomas A. Cernius, Beverly Shores, IN (US); Thanabalan Thavittupitchai Paul, Carmel, IN (US); Aaron Michael Smith, Noblesville, IN (US); Barry Jay Weber, Carmel, IN (US); Gary Robert Gutknecht, Noblesville, IN (US)

Correspondence Address: Thomson Licensing LLC, P.O. Box 5312, Two Independence Way, PRINCETON, NJ, 08543-5312, US

(21) Appl. No.: 12/150,479

(22) Filed: Apr. 29, 2008

(51) Int. Cl. H04N 7/173; H04L 12/26

(52) U.S. Cl. 725/107; 370/241; 348/180

(57) ABSTRACT

A method, system and computer readable medium box is disclosed for determining a networked device connection status of an IP set top. A signal strength parameter request is generated associated with the networked device's operation. This request is transmitted to a specific point in a network system where it is received at specific hardware and/or software point. Then a reply or signal strength parameter is generated in response to the signal strength parameter request. This reply or signal strength parameter is transmitted across the network system from the specific hardware and/or software point back to the networked device. There it is loaded into a signal strength parameter variable and displayed to the user.

### FIELD OF THE INVENTION

The present invention is generally related to improvements in set top box systems. More particularly, the present invention pertains to a method and system of improving network monitoring and retrieving parameters from network devices in a set top box system.

### BACKGROUND OF THE INVENTION

In a conventional set top box system (STB) the STB may receive programming from a satellite system. The satellite receives a microwave signal from earth (uplink), amplifies it and retransmits it back to earth at a different frequency (downlink). A satellite generally has many transponders for retransmitting the signal back to earth. Receivers back on earth tune to the transponder's transmit frequency in order to receive a desired signal which carries programming audio/video/data. The receiver down-converts the signal and sends it to a set top box which provides a user interface.

In the STB system the receiver may be separated from the tuner by a network. An example of such a system is shown in FIG. 1 where the set top box 100 is connected through a network 102 to a satellite receiver 104 through gateway 103. In such a system the set top box may communicate control signals to the satellite receiver 104, for example, sending a frequency/transponder signal strength request in order to retrieve the signal strength of the received satellite signal. Frequency/transponder signal strength requests are sent from the set top box 100 (or a test system, not shown) to the satellite receiver 104. The satellite receiver 104 reports back the strength of the signal from zero to one hundred percent. This is accomplished to identify signals that are excessively weak or non-existent.

However, the prior art only utilizes the direct physical signal strength measurement which gives an incomplete picture as to the status of the attempted connection from the STB to the receiver. In other words no status is provided with regard to any of the devices or software applications from the satellite receiver 104 to the set top box 100. The state of various physical connections, health of various physical connections, servers and peer to peer services availability all play a role in the connection. However, conventionally a user or installer of the STB cannot retrieve information, for example status information, with regard to these devices or software applications.

Signal strength measurements are typically taken in conjunction with tuning of a received RF or satellite signal. A problem exists in a IP network in that the signal tuning is performed by one device wherein a second device is used to generate the display signal for the display of the program carried by the RF or satellite signal. Thus, when setting up the display device, no immediate indication is available to indicate the signal strength of the received RF signal, this signal strength being used for troubleshooting the installation of the display device, for example. Accordingly, there exists a need for overcoming the disadvantages of the prior art that, as shown above, only provides a direct physical signal strength measurement.

### SUMMARY OF THE INVENTION

A method, system and computer readable medium for determining the status of a networked device and/or a software element in a network system is described herein. A signal strength parameter request is generated by a device connected to the network. This request is transmitted to a specific point, for example a hardware and/or software element in the network system. A reply, including a signal strength parameter, is generated in response to the signal strength parameter request. The reply is transmitted across the network system from the specific hardware and/or software element back to the originator of the request. The returned information is processed and/or displayed.

Another method, system and computer readable medium is disclosed that comprise ways to diagnose the status of the connection of a networked device. First, the status of a hardware and or software element in a network is observed by watching a signal strength parameter associated with the networked device. A determination is made, based upon the observation, as to the status of the hardware and or software element in the network using the signal strength parameter. The status information is processed and/or displayed.

### BRIEF DESCRIPTION OF THE FIGURES

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is an example of an IP Set Top Box Gateway Transponder system.

FIG. 2 is an example flow diagram for a signal strength parameter request and response.

FIG. 3 is another example flow diagram for a signal strength parameter request and response.

FIG. 4 is an example flow diagram for a signal strength parameter status monitoring, determination, loading and display in an alternative embodiment of the invention.

### DETAILED DESCRIPTION OF THE PREFERRED EMBODIMENTS

It is important to note that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views. It is important to note that for the purposes of this disclosure the term software is defined to include software or firmware, or a combination of the both of them.

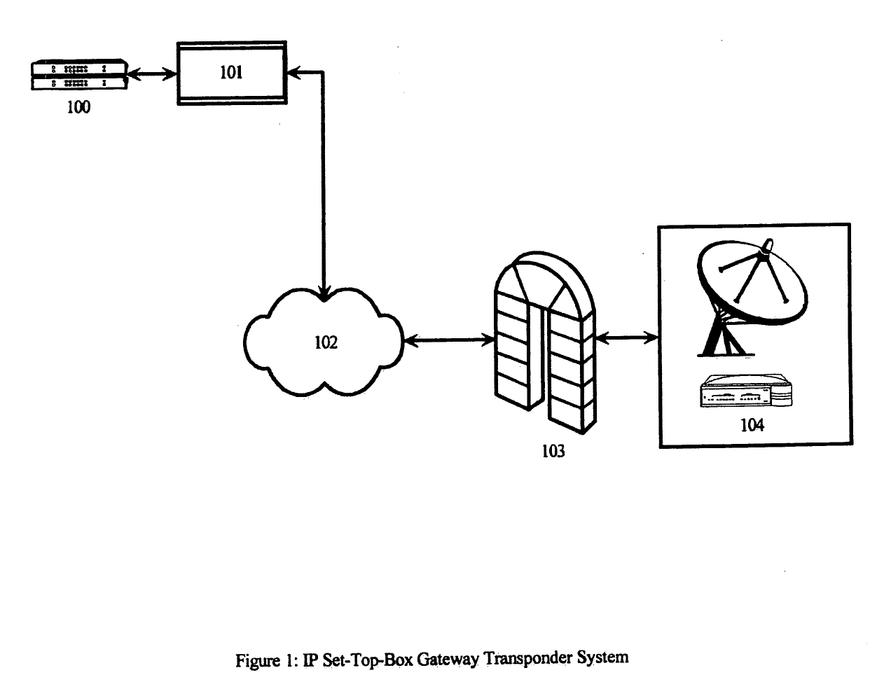

FIG. 1 is an illustration of a Set Top Box Gateway Transponder system within which the invention may be practiced. In an exemplary embodiment the system is an IP based system and is termed an IP Set Top Box system (IPSTB). In an IPSTB system the receiver is typically separated from the tuner by an IP network and the state of various physical connections, health of various physical connections, client-server and or peer to peer services availability is all useful information, for example, if trouble-shooting or monitoring the network. In one embodiment this information may be retrieved from any device or software element within the IPSTB system. The term “signal strength parameters” is used herein to represent the information retrieved from the devices or software element.

FIG. 1 shows an IPSTB 100 in communication with network 102. The communication may utilize middleware 101. A variety of data including, but not limited, to control, programming data, and or status data are transmitted and received across the network 102. The control, programming and/or status data are further transmitted and received across a gateway 103 that communicates with satellite transponder/receiver system 104. The satellite transponder/receiver system 104 receives data and transmits data to and from one or more satellites as well as receiving and transmitting data from network 102 across gateway 103.

It should be noted that network 102 represents in its broadest sense a generic communications network and is comprised of many different components including software, hardware and firmware. This is to be thought of as a generalized computer network but many specific implementations easily come to mind. These implementations include, but are not limited to, a wide area network (WAN), a local area network (LAN), an Appletalk network, the internet or world wide web or a generalized computer network. In particular, the network 102 is preferably implemented as the ubiquitous world wide web or internet.

The middleware 101 is utilized to connect a variety of software components so as to effect the retrieval of the signal strength parameters. Thus, the middleware operates between the application and the run time infrastructure. There are many other types of middleware such as Message Oriented Middleware (MOM), SQL Oriented Data Access, Object Request Broker (ORB), Remote Procedure Call (RPCs) amongst many others. Thus, middleware may be thought of as connectivity software that comprises a set of enabling services that allow multiple processes running on one or more machines to interact across the network.

For example, middleware 101 of FIG. 1 transmits requests for, and receives replies of, signal strength parameters from any device or network element. The middleware 101 may directly communicate with network 102 thus being in the ‘middle’ between IPSTB 100 software and network 102 software. Alternatively, middleware 101 communicates with network 102 through a network software element in the IPSTB 100 and communicates with the IPSTB 100 through IPSTB 100 control software; thus, the middleware 101 is situated between IPSTB 100 control software and IPSTB 100 network software. While illustrated as a separate unit, this should not be viewed as a limitation and is for conceptual purposes only. In any case, the middleware 101 transmits requests for, and receives replies of, the signal strength parameters.

In one embodiment, the middleware 101 acts as the IPSTB 100 test suite that is used by an installer to view the signal strength parameters and test signal strength characteristics. In this exemplary embodiment the middleware 101 may be located between the control and/or network software of the IPSTB 100 itself and the software of a connected test device or computer (not shown in the drawing). Thus, the communication may pass from the IPSTB 100 control software through the middleware 101 and on to the network 102; from the IPSTB 100 control software through the middleware 101 passing through an IPSTB 100 network software element; or from a test computer (not shown) through the middleware 101 to the IPSTB 100 and onto network 102. In other words, the middleware may be arranged in any of the possible orientations as described above.

As pointed out above the term signal strength parameters describes parameters useful in providing information of the status of the network and network services. For example, a plurality of signal strength parameters are utilized to generate a more complete picture of the status of a network connection. Each parameter may represent a different aspect of a network connection or a signal strength. For example, middleware 101 in FIG. 1 may send a request to satellite transponder system 104 or to gateway 103 and receive a response having one or more signal strength parameters.

In an exemplary embodiment there are six signal strength parameters, which may each be represented by a variable. The variables termed herein signal strength variables. The signal strength parameters and signal strength variables comprise a generic signal strength parameter and a generic signal strength variable that can alternatively represent any one of the below parameters and variables respectively; or they can represent these parameters and variables as well as others not listed below but contemplated in the broadest definition of this method. These parameters and variables are described below:

a. Signal Strength Parameters
1—Network Interface Connection Status and Enablement;
2—DHCP Network Service Operating and IPSTB Reception of an IP address;
3—IPSTB Gateway Visibility, in other words, that the IPSTB sees the Gateway;
4—IPSTB MDU Computer to Peer Computer Communication on Gateway;
5—Program Stream Multicast Data Reception at the IP Set Top Box; This also represents (at least) a minimal signal strength value as no Program Stream Multicast Data is sent by the Gateway if the signal strength at the Gateway tuner drops below some minimum value.
6—No Errors Detected.

This embodiment illustrates a tiered system in that a failure at a lower level implies that higher levels also fail; for example, a failure at level two implies that levels 3-6 also fail.

The Dynamic Host Configuration Protocol (DHCP) may be utilized in the network for the configuration of processing devices that utilize TCP/IP. It is useful in automatically providing TCP/IP configuration parameters such as the default router and subnet mask. Additionally, it is used to automatically provide IP addressing as well as other addresses for news servers and printers. The term MDU relates to a multi-dwelling unit. For example, an MDU delivers residential programming to each unit of a multi-dwelling unit via one satellite antenna and receivers in each unit or via headend without a receiver in each unit. The Gateway may be an IP Distribution Technology Gateway (IDT Gateway).

Each one of the above six parameters may be represented by a plurality of variables in a plurality of implementations of the invention's software as follows:

b. Signal Strength Variables
1—SS_NO_NETWORK_INTERFACE_ENUMERATED
2—SS_NO_IP_ADDRESS_OBTAINED
3—SS_NO_IDT_GATEWAYS_DISCOVERED
4—SS_NO_COMMUNICATION_WITH_GATEWAY
5—SS_NO_MULTICAST_DATA_FROM_PS
6—SS_NO_ERRORS

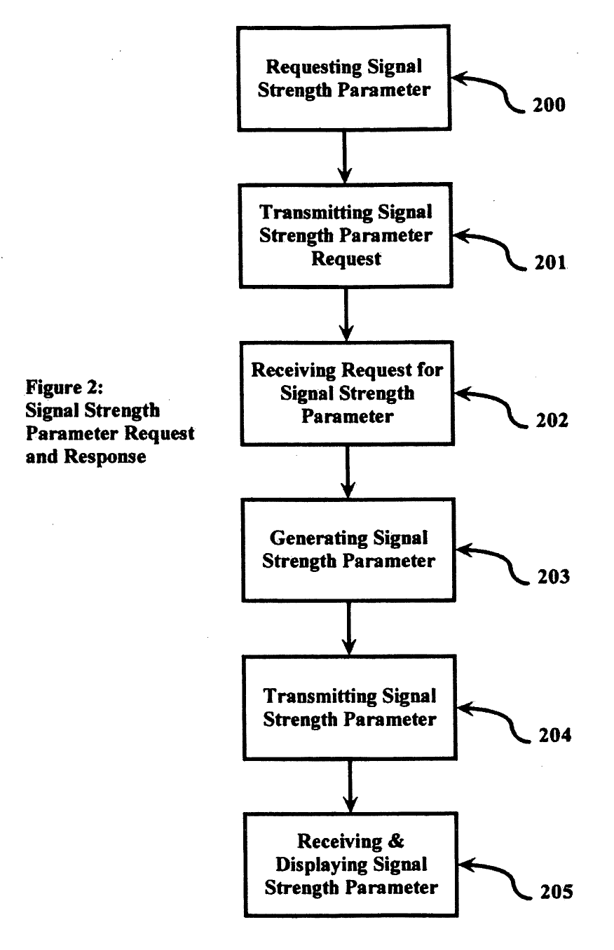

These programming variables listed immediately above this paragraph describe various connection issues that may be represented in this embodiment. The signal strength parameters and their associated signal strength variables are evaluated in software depending upon the response of the system utilizing, for example, the method as illustrated in FIG. 2 and described below.

FIG. 2 is an illustration of a method for generating a signal strength parameter request and receiving a response as practiced in an exemplary embodiment of the invention. First, the middleware requests a signal strength parameter in step 200. The request for the signal strength parameter is transmitted 201 from the middleware 101 through the IPSTB 101 utilizing the various configurations as described above. The signal strength parameter request may be transmitted to any point of hardware and or software in the system of FIG. 1 passing through any software and hardware onto its intended destination. The signal strength parameter request is received 202 at its destination point. The particular hardware and or software that is the destination of the request for the signal strength parameter generates 203 a signal strength parameter in response to the request. This generated signal strength parameter includes but is not limited to one or more parameters and in one example embodiment includes the parameters as described above.

The generic signal strength parameter, after having been generated at the destination point, is transmitted 204 from the destination point in the reverse direction. The generic signal strength parameter follows a return path until being received 205 at the middleware and IPSTB system. Once it arrives at the middleware, the generic signal strength parameter is loaded into a generic signal strength variable and displayed 205 to an installer or end user on buttons, menus, display lights, LEDs, an LCD display, a monitor, a touch screen display or some other generic user display device associated with the middleware and IPSTB 100 in a suitable configuration. These display devices may be integrated with the IPSTB 100 or separately disposed in a variety of different configurations.

A proper signal strength parameter reply indicates the status of the software and or hardware device. A proper reply means that the hardware and or software point is returning expected data values whether of a healthy or faulty nature. An improper signal strength parameter reply could also be received. An improper reply indicates that the hardware and or software device at the specific system or network point (device or software) to which the request was sent is communicating spurious responses.

The above description envisions the transmission of the request for a signal strength parameter to any point of the network, for example, a hardware device or software application of a device in the overall system; further, the most generalized understanding of the present invention returns a generic generated signal strength parameter back, from that point associated with a generic hardware and or software in the system, to the IPSTB and the middleware test suite.

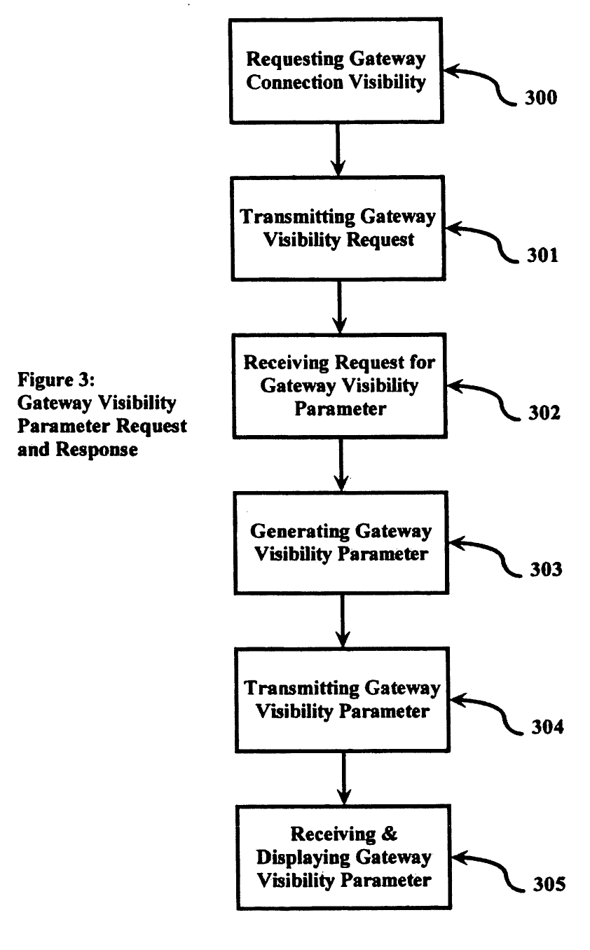

In another exemplary embodiment a signal strength parameter request is described with reference to FIG. 3. It should be emphasized that FIG. 3 represents a specific signal strength parameter request and response as taught by the invention. First, the middleware requests a Gateway Visibility signal strength parameter in step 300. Then the request for the Gateway Visibility signal strength parameter is transmitted 301 from the middleware 101 through the IPSTB 101 utilizing the various configurations as described above. The Gateway Visibility signal strength parameter request is transmitted to the Gateway 103 across network 102 in the system of FIG. 1 passing through any software and hardware to its intended destination. The Gateway Visibility signal strength parameter request is received 302 at the gateway 103. The particular hardware and or software of the gateway 103 that is the destination of the request for the Gateway Visibility signal strength parameter generates 303 a Gateway Visibility signal strength parameter in response to the request from middleware 101. This generated signal strength Gateway Visibility parameter includes but is not limited to a proper reply that indicates the status of the gateway hardware and/or software. In various embodiments the reply may include parameters and variables as discussed above. The reply may also be an improper reply that indicates the gateway 103 is communicating spurious responses or the request or response is not passing through the network.

After having been generated at the gateway 103, the Gateway Visibility signal strength parameter reply is transmitted 304 from the gateway 103 in the reverse direction. It passes through the necessary software and hardware from gateway 103 onto the network 102 and finally is received 305 at the middleware and IPSTB system. Once it arrives at the middleware the signal strength parameter is processed or displayed 305 to an installer or end user on buttons, menus, display lights, LEDs, an LCD display, a monitor, a touch screen display or some other generic user display device associated with the middleware and IPSTB 100 and or a user test computer in a suitable configuration. These display devices may be integrated with the IPSTB 100 or separately disposed in a variety of different configurations.

In a further embodiment, each of the above described signal strength parameters directly correspond with the signal strength variables. As mentioned above, this is preferably a tiered system such that a failure at a lower level implies that higher levels also fail; for example, a failure at level two implies that levels 3-6 also fail.

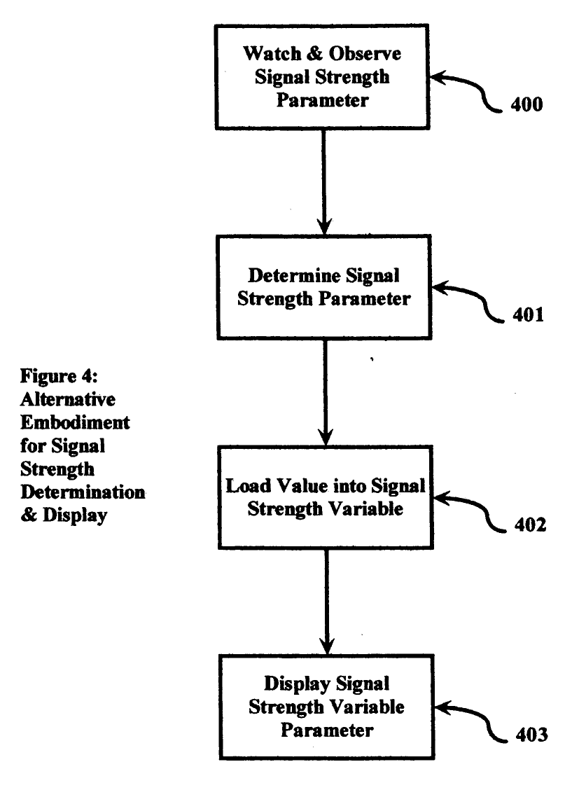

An alternative embodiment is herein disclosed that contemplates a more passive attitude to the hardware and/or software device under test. In the implementation as described in FIG. 2 a request is made to a generalized point of hardware and/or software in the system in order to receive some reply from that generalized point of hardware and or software. However, in this alternative embodiment as illustrated in FIG. 4, the middleware simply watches or observes 400 the ordinary operation of the IPSTB or generic network device and its communication across the system in order to determine the status of a variety of different signal strength parameters as described above.

In this embodiment, the status of one or more signal strength parameters are determined 401 or diagnosed by watching the communication from the hardware and/or software under test; then a status value is generated representing the one or more parameters. This status of the signal strength parameter includes but is not limited to a proper status that indicates the status of the software and/or hardware device or an improper status. A proper status means that the hardware and/or software element is returning expected data values whether of a healthy or faulty nature whilst an improper reply indicates that the hardware/or software device at the specific system or network point is communicating spurious responses.

Then, the status value of the one or more different parameters is loaded 402 into the signal strength variables as shown above. Finally, the value comprising the signal strength variable is displayed 403 to an end user through the use of a one or more of a variety of visual indicators such as the following: buttons, menus, display lights, LEDs, an LCD display, a monitor, a touch screen display or some other generic user display device associated with the middleware and IPSTB 100 in a suitable configuration. These display devices may be integrated with the IPSTB 100 or separately disposed in a variety of different configurations.

The above description has been tailored to a signal strength parameter observation associated with the interpretation of the alternative embodiment. Further, the generalized understanding also includes the determination of the generic signal strength status value, the loading of that signal strength value into a signal strength variable and then the display of the value to a user at the IPSTB and the middleware test suite.

### Discussion of Hardware and Software Implementation Options

The present invention, as would be known to one of ordinary skill in the art could be produced in hardware or software, or in a combination of hardware and software. The system, or method, according to the inventive principles as disclosed in connection with the preferred embodiment and other embodiments, may be produced in a single computer system having separate elements or means for performing the individual functions or steps described or &claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment and other embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory, or may be on a transportable medium such as a disk, or a fixed disk, or a memory stick, or any other type of memory as known to those of ordinary skill in the art.

The invention is not limited to any particular computer program or logic or language instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, disk drive memory, CD-ROM, and other permanent storage. Additionally, a computer readable medium may include, for example, volatile storage, such as RAM, buffers, cache memory, and network circuits.

Further, the computer readable medium may include computer readable information in a transitory state medium such as a network link and/or a network interface, including a wired network or a wireless network, that allow a computer to read such computer readable medium.

What is claimed is:

1. A method comprising the steps of:
generating a request for data associated with the operation of a networked device;
transmitting the request over a network;
receiving data in response to the request; and
generating a signal strength parameter in response to the data.

2. The method of claim 1, further comprising the step of:
transmitting the signal strength parameter over the network.

3. The method of claim 1, further comprising the step of:
displaying the generic signal strength parameter onto a user display.

4. The method of claim 1, wherein the networked device further comprises an IP set top box.

5. The method of claim 1, wherein the data comprises at least one of a network adapter parameter, a DHCP IP address parameter, a gateway discovered parameter, a gateway communication parameter, a data received parameter, an error parameter, and a generic parameter.

6. The method of claim 1, wherein the signal strength parameter comprises at least one of a network adapter variable, a DHCP IP address variable, a gateway discovered variable, a gateway communication variable, a data received variable, an error variable, and a generic variable.

7. An apparatus comprising:
a processor operative to generate a data request indicative of the status of a program signal being processed by a first networked device and generate a signal parameter in response to the data;
a transmitter operative to transmit the data request over a network to said networked device and to transmit the signal parameter to a second networked device; and
a receiver operative to receive said data.

8. The apparatus of claim 7, further comprising a display for displaying the signal parameter variable.

9. The apparatus of claim 7 wherein the signal parameter at least one of a network adapter parameter, a DHCP IP address parameter, a gateway discovered parameter, a gateway communication parameter, a data received parameter, an error parameter, and a generic parameter.

10. The apparatus of claim 7 wherein the data comprises at least one of a network adapter variable, a DHCP IP address variable, a gateway discovered variable, a gateway communication variable, a data received variable, an error variable, and a generic variable.

11. A method of determining a connection status of a networked device comprising the steps of:
observing a status of a point in a network by monitoring a signal strength parameter associated with the networked device;
determining the status of a point in the network using the observed signal strength parameter;
generating a value representing the generic signal strength parameter.

12. The method of claim 13, wherein the networked device further comprises an IP set top box and wherein the generic signal strength parameter comprises a parameter from a list of signal strength parameters comprising: a network adapter parameter, a DHCP IP address parameter, a gateway discovered parameter, a gateway communication parameter, a data received parameter, an error parameter, and a generic parameter.

13. The method of claim 13, wherein the networked device further comprises an IP set top box and wherein the generic signal strength variable comprises a variable from a list of signal strength variables comprising: a network adapter variable, a DHCP IP address variable, a gateway discovered variable, a gateway communication variable, a data received variable, an error variable, and a generic variable.

14. A method comprising the steps of:
transmitting a request for a data over a network, said data indicating a connection status of a program signal;
receiving said data; and
generating a signal strength parameter in response to the data.

15. The method of claim 14, further comprising the step of:
transmitting the signal strength parameter to a program signal processing device.

16. The method of claim 14, further comprising the step of:
displaying the signal strength parameter variable onto a user display.

17. The method of claim 15, wherein the program signal processing device further comprises an IP set top box.

18. The method of claim 14, wherein the data comprises at least one of a network adapter parameter, a DHCP IP address parameter, a gateway discovered parameter, a gateway communication parameter, a data received parameter, an error parameter, and a generic parameter.

19. The method of claim 6, wherein the signal strength parameter comprises at least one of a network adapter variable, a DHCP IP address variable, a gateway discovered variable, a gateway communication variable, a data received variable, an error variable, and a generic variable.
